(19) United States
(12) Patent Application Publication
(10) Pub. No.: US 2019/0014951 A1
(43) Pub. Date: Jan. 17, 2019

(54) COOKS DRIP RACK CADDY

(71) Applicant: LARONDAR ANN STONE, WESLEY CHAPEL, FL (US)

(72) Inventor: LARONDAR ANN STONE, WESLEY CHAPEL, FL (US)

(21) Appl. No.: 15/648,118

(22) Filed: Jul. 12, 2017

(51) Int. Cl. A47J 47/16

(52) U.S. Cl. CPC A47J 47/16; A47K 10/22

(57) ABSTRACT

The Cooks Drip Rack Caddy particularly provides a removable drip pan for easy collection and clean-up of grease & debris as well as organization and cleanliness of cooking utensils, as well as the surrounding cooking areas. The Cooks Drip Rack Caddy can hang on the side of a grill, be wall mounted, or be a stand-alone utility that can hold numerous cooking, grilling, and barbecue utensils, along with a towel bar for paper towels or hand towels, as well as a bottle opener.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING

Not Applicable.

### BACKGROUND OF THE INVENTION

Cooks would prefer to have an easily accessible location to keep their cooking and grilling utensils organized, as well as keep their cook space clean of grease dripping and debris. Prior to the present invention these items are laid around the cooking area and grease and debris gets on said items and the surrounding cook space. The present invention, will keep cooking and grilling utensils organized and provide a way to keep grease dripping and debris in an easy to dispose of manner, which ultimately results in keeping cook tops and grill patio areas clean.

### SUMMARY OF THE INVENTION

Accordingly, the present invention features a cooking and grilling organization that provides a way to keep cooking utensils clean and organized as well as collect grease drippings & debris from those utensil into a drip tray that can be easily removed and cleaned.

### BRIEF DESCRIPTION OF THE SEVERAL VIEWS OF DRAWINGS

The accompanying proto type figures are included to provide a further understanding of the present invention and are incorporated into and constitute a part of the specification. It is understood that the figures are not to scale and that other details difficult to see may be omitted. The illustrations show varying embodiments of the present invention and, together with the description, serve to explain the principles of the present invention. Accordingly, the present invention has three major parts consisting of the frame, the drip tray, and the towel rack.

FIG. 1—Shows a front perspective full rendering drawing of the Cooks Drip Rack Caddy frame (FIG. 1.1) which depicts two towel bar slots, one on each side of the frame (FIG. 1.2), four each of the utensil hooks (FIG. 1.3), the stability wire mesh backing (FIG. 1.4), the removable drip tray compartment (FIG. 1.5), and the frame base (FIG. 1.6).

FIG. 2—Shows a front perspective full rendering drawing of the Cooks Drip Rack Caddy removable drip tray (that fits into the drip tray compartment).

FIG. 3—Shows a front perspective full rendering proto type of the Cooks Drip Rack Caddy removal towel rack (that fits into the towel bar slots).

FIG. 4—Shows the back perspective full rendering drawing of the Cooks Drip Rack Caddy frame (FIG. 4.1), two towel bar slots, one on each side of the frame (FIG. 4.2), four each of the utensil hooks (FIG. 4.3), the stability wire mesh backing (FIG. 4.4), the removable drip tray compartment (FIG. 4.5), the frame base (FIG. 4.6), two wall hanging hooks one on each top right and top left corners (FIG. 4.7), and two protective wall guards, one each on the bottom right and bottom left corners (FIG. 4.8)

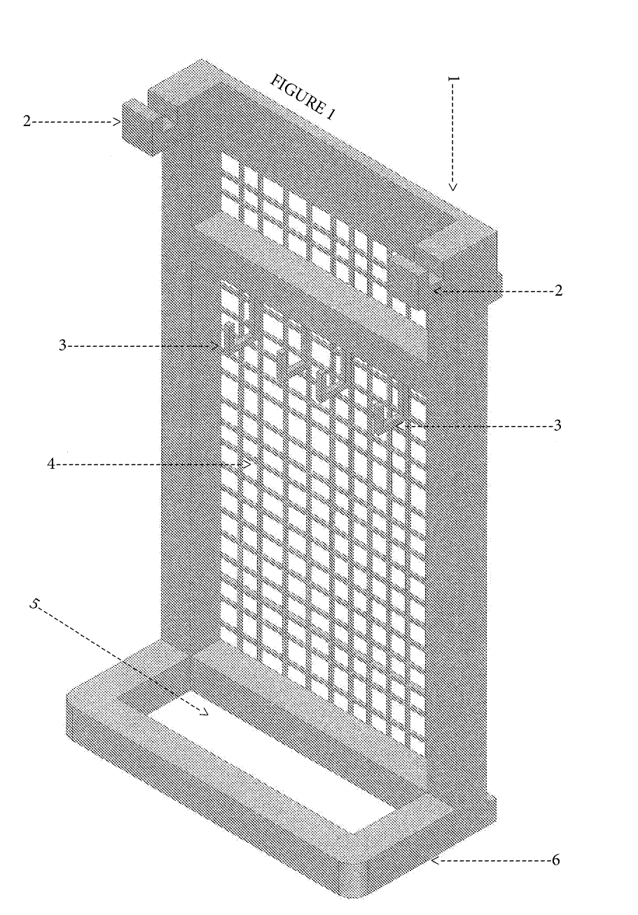

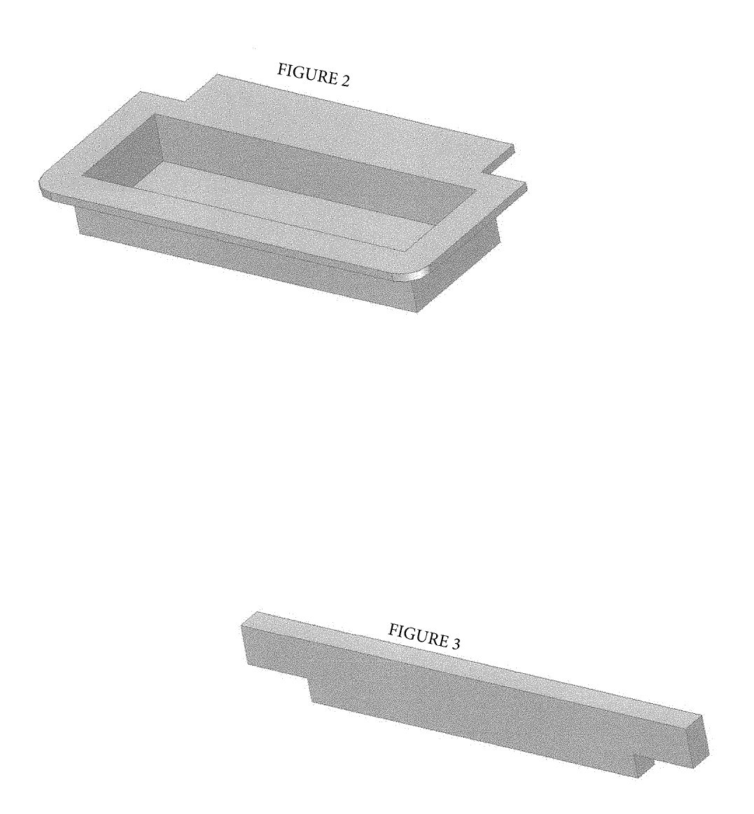

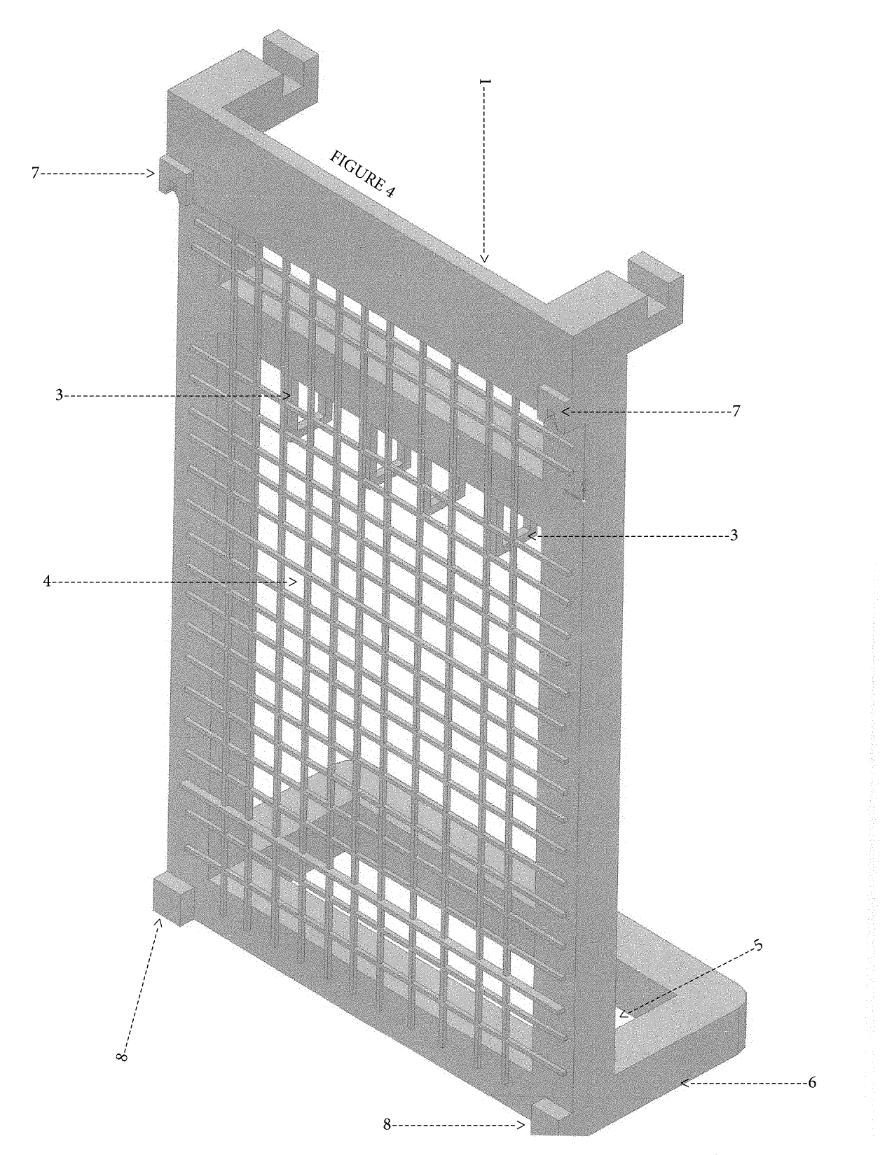

### DETAILED DESCRIPTION OF THE INVENTION

Referring now in more detail, the present invention is directed for the use of collecting grease and debris from utensils being used and for clean and organizational cooking, grilling, and barbecue. The present invention is comprised of three major parts, the body structure, the drip tray, and the towel rack. The body structure consist of the frame with stability wire backing, utensil hooks, the drip tray compartment, the towel bar support, wall mounting hooks, wall guard, and a bottle opener. The drip tray is rectangular in shape with extended edges on all four sides. The towel rack is circular in shape providing adequate space for paper towel rolls or hand towel. The present inventions overall dimensions are 26″ in height by 7.5″ in depth by 15″ in width that consist of three parts, the Base, the Drip Tray, and the Frame. The Invention BASE consist of 2 each pieces of * Building Material, in this instance is wood lumber that are 6″ in length by 1.5″ in width that are the left and right pieces of the base; 2 each pieces of lumber that are 12″ in length by 1.5″ in width, that back up the front and back pieces of the base, all four pieces are affixed by 2 screws at each connecting joint. The invention Drip TRAY consist of 1 silicone composite material that is heat resistant and dish washer safe; that is 11″ in length by 4″ in width by 1.5″ in depth with a ½″ lip around 3 of the 4 parts that make up the front and the sides, and a 1″ lip around the 4^{th} part that make up the rear. The Invention FRAME consist of 2 each pieces of lumber that are 26″ in height by 1.5″ in width that are the left and right pieces of the frame; 1 each piece of lumber that is 12″ in length by 1.5″ in width that make up the hook rack for the 4 hook screws that are 3⅜″; 2 each pieces of lumber that are 2″ in length by 1.5″ in width that make up the towel rack and 1 piece of lumber that is 1.5″ in length by 1.5″ in width that make up the towel bar (slightly rounded); 1 each piece of lumber that is 15″ in length by ½″ in width that doubles as the back of the frame and the wall mount with 2 each pieces of wall mounting brackets; 2 each pieces of rubber wall guards; 1 each metal bottle opener affixed to the front right of the FRAME; 1 metal wire meshing that is 22″ in height by 14″ in width that provide stability and hold all FRAME pieces together.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention. The Invention's * Building Material, can consist of ie wood, composite wood, metal, plastic, etc.

What is claimed is:

1. (canceled)

2. A vertically extending upright unit comprising of a left and right side rectangular member, a top flat rectangular member that is recessed to accommodate a full paper towel roll, and a bottom rectangular member that is shorter in length than the left and right side rectangular members, all members enclosing a wire grid that is attached to the back of the left and right side rectangular members, as well as being attached to the top and bottom rectangular members that provides stabilization to the entire structure, the front right side rectangular member consists of a bottle opener to be used to remove beverage caps, attached to the top front vertical rectangular member there are U-shaped support brackets that extend perpendicular bilaterally of the left and right front side rectangular vertical members, there is a removable towel bar that extends horizontally and is rectangle in shape with cut out ends that are specifically shaped to fit into the U-shaped support brackets, there is a rectangular member extending horizontally that fits inside the left and right vertical rectangular members and is in front of the enclosed stabilizing wire grid that has 4 equally spaced utensil hooks screwed into the bottom side of that member that hang down forward facing and is used to hold cooking utensils, attached to the front of the bottom of the left and right vertical rectangular members and extending perpendicular and attached by a rectangular member extending horizontally creating an enclosing compartment that holds a drip tray that is rectangle in shape, approximately two inches in depth with rims that extend horizontal and perpendicular for the purpose to catch spillage and other debris that falls from the utensil during use, attached to the back of the top flat rectangular member on the left and right sides are wall mounting hooks that enable the entire unit to hang on the wall, attached to the back on the bottom rectangular member on the left and right sides are wall protective guards made of rubber and used to level the unit while hanging on the wall as well preventing tipping when free standing.
